(19) United States
(12) Patent Application Publication
(10) Pub. No.: US 2021/0317943 A1
(43) Pub. Date: Oct. 14, 2021

(54) DISPLAY DEVICE

(71) Applicant: SAMSUNG ELECTRONICS CO., LTD., Suwon-si, Gyeonggi-do (KR)

(72) Inventors: Suk Jo KANG, Suwon-si (KR); Yeong Sik LEE, Cheonan-si (KR)

(73) Assignee: SAMSUNG ELECTRONICS CO., LTD., Suwon-si, Gyeonggi-do (KR)

(21) Appl. No.: 17/273,576

(22) PCT Filed: Sep. 4, 2019
(86) PCT No.: PCT/KR2019/011429

§ 371 Date: Mar. 4, 2021

(30) Foreign Application Priority Data
Sep. 6, 2018 (KR) 10-2018-0106282

(51) Int. Cl. F16M 11/16; G06F 1/18; F16M 13/00

(52) U.S. Cl. CPC F16M 11/16; F16M 13/005; G06F 1/181

(57) ABSTRACT

The present disclosure relates to a display apparatus including a display panel configured to display an image forward, a top chassis arranged on a front side of the display panel, a bottom chassis arranged on a rear side of the display panel, a rear cover covering a rear side of the bottom chassis, and a stand unit arranged between the bottom chassis and the rear cover and coupled to the rear surface of the bottom chassis, wherein the stand unit including a housing coupled to the bottom chassis, a stand configured to be received in the housing through an opening formed on a lower side of the housing, and an elastic member configure to transmit a tensile (elastic) force to the stand from an upper inside of the housing.

### TECHNICAL FIELD

The present disclosure relates to a display apparatus, and more particularly, to a display apparatus including a stand member.

### BACKGROUND ART

Generally, display apparatuses are devices for displaying an image, such as a monitor or a television. A self-light emitting display panel, such as an organic light-emitting diode (OLED), or a light-receiving/emitting display panel, such as a liquid crystal display (LCD) panel, is used in a display apparatus.

The present disclosure relates to a display module and a display apparatus to which the light-receiving/emitting display panel is applied. The display apparatus to which the light-receiving/emitting display panel is applied includes a display panel consisting of a liquid crystal panel and displaying an image, and a backlight unit supplying light to the display panel. The backlight unit includes a light source module having a light source and a plurality of optical sheets receiving light from the light source and guiding the light to the display panel.

Conventional display apparatuses may be used by installing the display apparatus on a wall or supporting the display apparatus on a floor by a stand depending on a user's preference.

### DISCLOSURE

### Technical Problem

It is one aspect of the present disclosure to provide a display apparatus including an improved structure for selectively receiving a stand on which the display apparatus is installed.

It is another aspect of the present disclosure to provide a display apparatus including a stand that is not exposed to an outside when the display apparatus is installed on a wall.

### Technical Solution

An aspect of the present disclosure provides a display apparatus including a display panel configured to display an image forward, a top chassis arranged on a front side of the display panel, a bottom chassis arranged on a rear side of the display panel, a rear cover covering a rear side of the bottom chassis, and a stand unit arranged between the bottom chassis and the rear cover and coupled to the rear surface of the bottom chassis, wherein the stand unit including a housing coupled to the bottom chassis, a stand configured to be received in the housing through an opening formed on a lower side of the housing, and an elastic member configure to transmit an elastic force to the stand from an upper inside of the housing.

The housing may include a coupling portion disposed on an upper side of the housing and coupled to an upper end of the elastic member, and the stand is coupled to a lower end of the elastic member.

The stand further may include a protrusion member, and the housing may further include a rail configured to guide the protrusion member.

The rail may include a first section guiding the protrusion member in a vertical direction, a second section extending from the first section and guiding the protrusion member to be rotated and moved, and a third section extending from the second section and guiding the protrusion member in a horizontal direction.

The rail may include a first stopper provided at one end of the rail and restricting the protrusion member from moving upward, and a second stopper provided at the other end of the rail and restricting the protrusion member from moving upward.

The stand may be provided to be movable vertically by a distance between the first stopper and the second stopper.

The stand may be provided such that when the protrusion member is placed on the second stopper, the protrusion member may be rotated by 90 degrees compared to when the protrusion member is placed on the first stopper.

The stand may further include a receiving portion at least partially received in the housing and a support portion extending downward from the receiving portion and supporting the display apparatus, and the protrusion member may be provided on the receiving portion.

The receiving portion may be configured to be withdrawn from the rear cover to support the display apparatus when the protrusion member is placed on the second stopper.

The rail may be provided to rotate 90 degrees while the stand is moved in the vertical direction.

The housing may include a first housing including a coupling portion to which an upper end of the elastic member is coupled and a guide portion for guiding the stand, and a second housing on which the rail is provided.

The second housing may further include a bracket coupled to the bottom chassis, and the first housing may further include a fixing portion fixed to the bracket.

The stand may be configured to move between a first position in which the stand is received in the housing and a second position in which the stand is withdrawn and supports the display apparatus, and when the stand is placed on the first position, a lower end of the stand may be provided to correspond to a lower end of the rear cover in a front-rear direction or higher than the lower end of the rear cover.

The rear cover may include a through hole through which the stand passes in a vertical direction.

The lower end of the stand may be provided to correspond to a lower end of the display apparatus in a front-rear direction or higher than the lower end of the display apparatus when the stand is placed on in the first position.

### Advantageous Effects

In the present disclosure, when the stand for installing the display apparatus is installed on a wall, the stand can be received in the display apparatus, and when the display apparatus is installed on a floor, the stand can be withdrawn from the display apparatus to support the display apparatus. Accordingly, the stand for installing the display apparatus does not need to be stored separately, thereby preventing the stand from being lost.

In addition, according to the present disclosure, when the display apparatus is installed on the wall, the stand can be received in the display apparatus not to be exposed to an outside, thereby creating aesthetic sense.

### DESCRIPTION OF DRAWINGS

FIG. 1 is a perspective view of a display apparatus, according to an exemplary embodiment of the present disclosure.

FIG. 2 is an exploded perspective view of the display apparatus, according to the exemplary embodiment of the present disclosure.

FIG. 3 is an exploded view of a partial configuration of the display apparatus, according to the exemplary embodiment of the present disclosure.

FIG. 4 is a partial cross-sectional view of the display apparatus, according to the exemplary embodiment of the present disclosure.

FIG. 5 is an exploded perspective view of a stand unit of the display apparatus in an insertion position, according to the exemplary embodiment of the present disclosure.

FIG. 6 is a rear view of the stand unit of the display apparatus in the insertion position, according to the exemplary embodiment of the present disclosure.

FIGS. 7A to 7C are views schematically showing an operation of the stand unit of the display apparatus, according to the exemplary embodiment of the present disclosure.

FIG. 8 is a rear view of the stand unit of the display apparatus in a withdrawal position according to the exemplary embodiment of the present disclosure.

FIG. 9 is an exploded perspective view of the stand unit of the display apparatus in the withdrawal position, according to the exemplary embodiment of the present disclosure.

FIGS. 10A to 10B are rear perspective views of the stand unit of the display apparatus in the insertion position and the withdrawal position, according to the exemplary embodiment of the present disclosure.

### MODE OF THE INVENTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another. For example, without departing from the scope of the present disclosure, the first component may be referred to as a second component, and similarly, the second component may also be referred to as a first component. The term “and/or” includes any combination of a plurality of related items or any one of a plurality of related items.

Hereinafter, exemplary embodiments of the present disclosure will be described in detail with reference to the accompanying drawings.

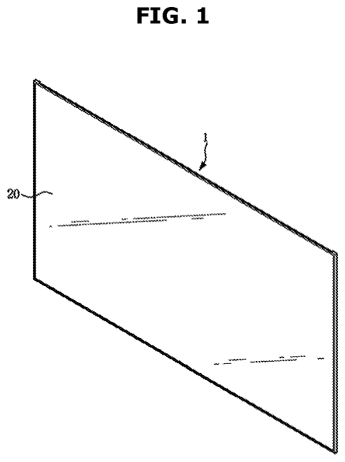

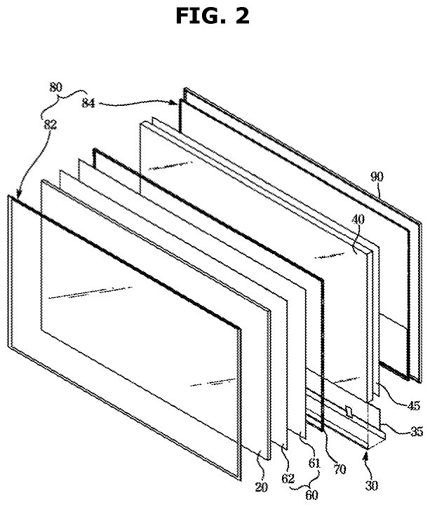

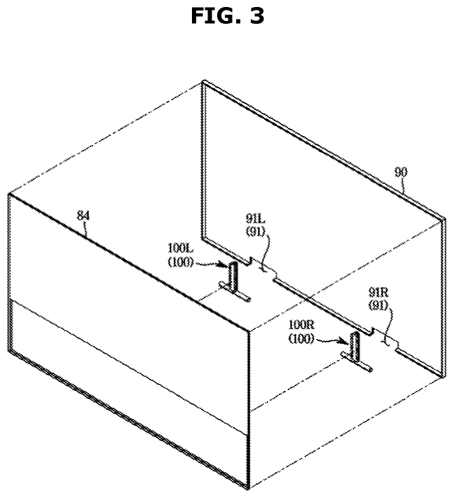

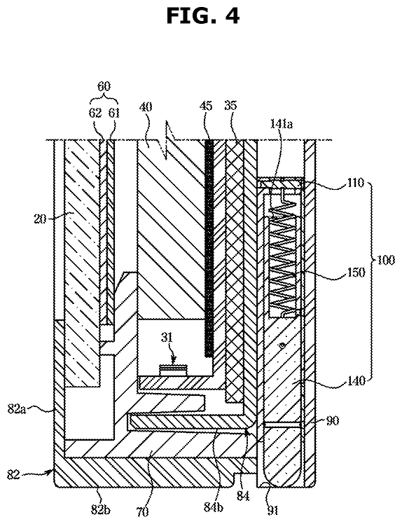

FIG. 1 is a perspective view of a display apparatus according to an exemplary embodiment of the present disclosure, FIG. 2 is an exploded perspective view of the display apparatus according to the exemplary embodiment of the present disclosure, FIG. 3 is an exploded view of a partial configuration of the display apparatus according to the exemplary embodiment of the present disclosure, and FIG. 4 is a partial cross-sectional view of the display apparatus according to the exemplary embodiment of the present disclosure.

While the description of the present disclosure illustrates a flat display apparatus 1 as an example, it may be applied to a curved display apparatus or a bendable display apparatus.

The terms ‘front’ and ‘front surface’ used herein are based on a front surface of a display panel 20 side which displays an image, based on the display apparatus 1 illustrated in FIG. 1. Based on the above, the terms ‘upper (or top)’ and ‘lower (or bottom)’ indicate an upper side and a lower side of the display apparatus 1 illustrated in FIG. 1, and the terms ‘opposite sides’ and ‘one side’ indicate left and right directions of the display apparatus 1 illustrated in FIG. 1.

The display apparatus 1 includes a display module for displaying an image therein.

The display module includes a display panel 20 on which an image is displayed and a backlight unit configured to supply light to the display panel 20. The backlight unit may include a light source module 30 and an optical sheet 60. Specifically, the backlight unit may include the light source module 30 disposed in a rear of the display panel 20, a light guide plate 40 disposed in a space between the display panel 20 and the light source module 30 such that light transmitted from a rear side thereof is diffused and transmitted to the display panel 20 positioned at a front side thereof, the optical sheet 60 disposed between the light guide plate 40 and the display panel 20 to change optical properties, a middle mold 70 configured to support the display panel 20 and the light guide plate 40, and a display chassis 80 forming an exterior thereof. The display chassis 80 includes a top chassis 82 coupled to a front side of the middle mold 70 to maintain a state in which the display panel 20 is installed on the middle mold 70, and a bottom chassis 84 coupled to a rear side of the middle mold 70 and in which the above-described light source modules 30 are disposed on inner opposite sides thereof.

The light source module 30 may be arranged inside the bottom chassis 84 to irradiate light toward an inner center side of the bottom chassis 84. In the embodiment of the present disclosure, the light source modules 30 are arranged on a lower portion of the display module, but is not limited thereto, and may be applied only to at least one side of the lower portion, sides, or the upper portion of the display module, or may be applied along edges of the display module entirely. That is, the light source may be applied as such an edge type display manner, or a direct type display manner. However, for convenience of description, the display apparatus 1 to which the edge type display manner is applied will be described below.

The light guide plate 40, the display panel 20, and the top chassis 82 are sequentially installed on the front side of the middle mold 70, and the bottom chassis 84 is installed on the rear side of the middle mold 70, so that respective components are supported by the middle mold 70 and the display panel 20 and the bottom chassis 84 are maintained in a state of being spaced apart from each other.

The top chassis 82 includes a bezel portion 82a covering a front outer side of the display panel 20, and a top side portion 82b bent backward from at end part of the bezel portion 82a to cover a side surface of the middle mold 70.

The bottom chassis 84 includes a rear side portion forming a rear surface of the display module, and a bottom side portion 84b extending forward from a circumference of the rear side portion to couple to the inside of the middle mold 70.

The light source modules 30 may include a light source package 31 and a printed circuit board.

A light source of the light source package 31 includes a light emitting device (LED). A plurality of the light source packages 31 may be provided, and the plurality of the light source packages 31 may be arranged to be spaced apart from each other at predetermined intervals. The plurality of the light source packages 31 may be arranged to be spaced apart from each other on the printed circuit board. The light source modules 30 may further include a heat dissipation member 35 that radiates heat generated from the light source packages 31 and the printed circuit board 38.

The light guide plate 40 is disposed to be spaced apart from the bottom chassis 84, so that the light source modules 30 is disposed on opposite sides of a space between the light guide plate 40 and an inner surface of the bottom chassis 84, that is, on the bottom side portion 84b side.

The light guide plate 40 may include a reflection member 45 on a rear surface thereof. The reflection member 45 may be provided on the rear surface of the light guide plate 40 so that all light generated from the light source packages 31 may direct to a front side thereof. The reflection member 45, which is a reflector, may be configured separately from the light guide plate 40 and arranged on the rear surface of the light guide plate 40, or may be formed integrally with the light guide plate 40. In addition, by applying a reflective coating on the rear surface of the light guide plate 40, the same effect as described above may be obtained.

The light guide plate 40 is provided to transmit light generated from the light source. To this end, the light guide plate 40 may be formed of a transparent resin material. The light guide plate 40 may be arranged to be spaced apart from the light source at a predetermined interval to minimize deformation due to heat generated from the light source.

A rear cover 90 may be disposed at the rear side of the bottom chassis 84 to cover the rear of the bottom chassis 84 and form an exterior of the display apparatus 1.

The display apparatus 1 may be installed on a wall (a mount type), or placed on a floor with a stand (a stand type), depending on needs of a user.

Generally, when the display apparatus is installed on the wall, the stand for installing the display apparatus is separately stored, and in this case, the stand may be lost in the future.

For example, the user may install the display apparatus in the mount type or the stand type depending on a space. However, when changing the installation of the display apparatus from the mount type to the stand type, in the case of the stand stored separately is lost, a problem may occur.

To solve this problem, in the display apparatus 1 according to embodiments of the present disclosure, a stand for installing the display apparatus is coupled to the display apparatus 1, thereby preventing a problem in which the stand is lost.

Specifically, the display apparatus 1 includes a stand unit 100, and when the display apparatus 1 is installed on the wall, a stand 140 may be inserted into the display apparatus 1, and when the display apparatus 1 is installed on the floor, the stand 140 may be withdrawn from the display apparatus 1 to support the display apparatus 1 from the floor.

Hereinafter, this will be described in detail below. As shown in FIG. 3, two stand units 100R and 100L may be provided on left and right sides with respect to a longitudinal direction of the display apparatus 1, respectively. In addition, the rear cover 90 may include two through holes 91R and 91L through which the two stand units 100R and 100L may pass. The stand units 100R and 100L are arranged in the same configuration on the left and right sides of the display apparatus 1, so for convenience of explanation, one of the two stand units (100R, 100L) will be mainly described (hereinafter, referred to as 100). In addition, the number of stand units 100 is not limited thereto, and may be provided in two or more.

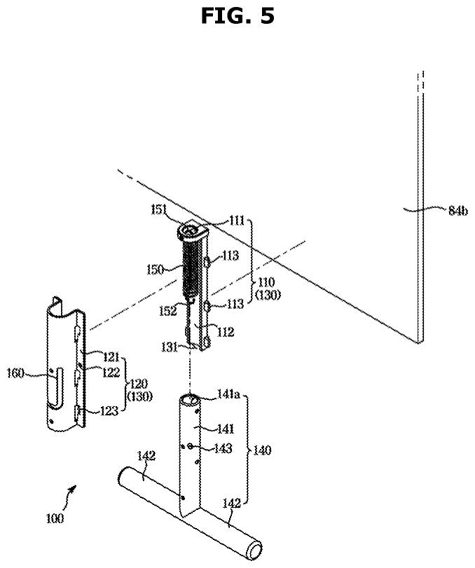

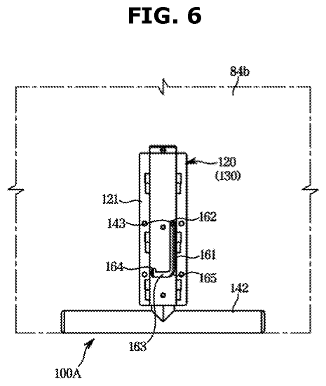

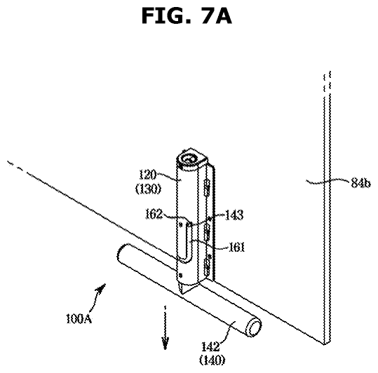

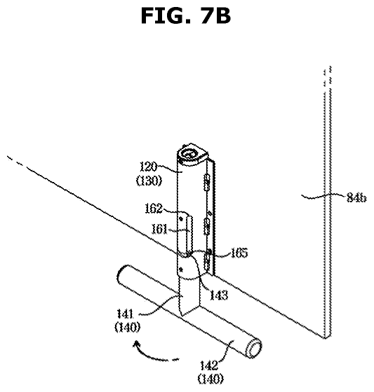

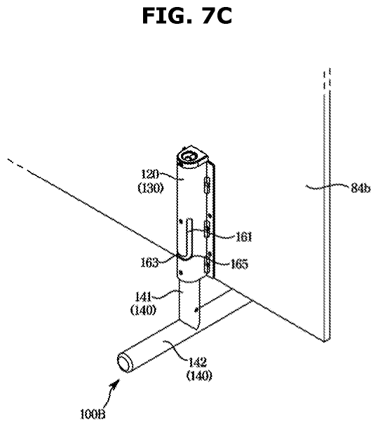

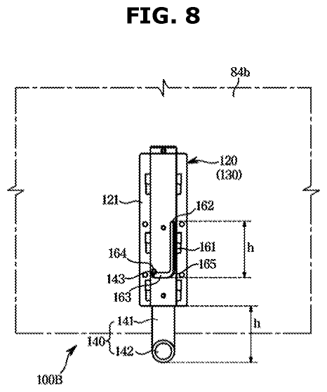

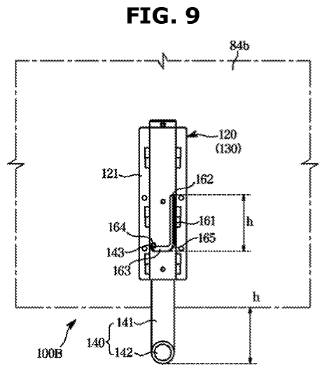

FIG. 5 is an exploded perspective view of the display apparatus in an insertion position of the stand unit according to the embodiment of the present disclosure, FIG. 6 is a rear view of the stand unit of the display apparatus in the insertion position according to the embodiment of the present disclosure, FIGS. 7A to 7C are views schematically showing an operation of the stand unit of the display apparatus according to the embodiment of the present disclosure, FIG. 8 is a rear view of the stand unit of the display apparatus in a withdrawal position according to the embodiment of the present disclosure, and FIG. 9 is an exploded perspective view of the stand unit of the display apparatus in the withdrawal position according to the embodiment of the present disclosure.

The stand unit 100 may be disposed between the bottom chassis 84 and the rear cover 90 (refer to FIGS. 3 and 4). The stand unit 100 may be disposed in an empty space between the bottom chassis 84 and the rear cover 90 in which no electrical parts (not shown) are disposed. Furthermore, as shown in FIG. 5, the stand unit 100 may be coupled to the rear surface 84b of the bottom chassis 84.

The stand unit 100 may include a housing 130 coupled to the rear surface 84b of the bottom chassis 84, the stand 140 provided to be received in the housing 130 through an opening 131 formed at a lower side of the housing 130, and an elastic member 150 for exerting an elastic force to the stand 140 from an upper inside of the housing 130.

The housing 130 may include a first housing 110 including a coupling portion 111 to which an upper end 151 of the elastic member 150 is coupled and a guide portion 112 for guiding the stand 140. The housing 130 may include a second housing 120 including a rail 160 for guiding movement of the first housing 110 and the stand 140.

The second housing 120 may include a bracket 121 coupled to the rear surface 84b of the bottom chassis 84. The bracket 121 includes a coupling hole 122, and the bracket 121 may be coupled with the bottom chassis 84 by passing a screw or the like through the coupling hole 122. In addition, the bracket 121 may include a fixing portion 123 coupled with the first housing 110 to be fixed the first housing 110.

The first housing 110 may include a fixing protrusion 113 provided to correspond to the fixing portion 123 so as to be coupled to the fixing portion 123 of the second housing 120. When the first housing 110 and the second housing 120 are coupled, the fixing protrusion 113 may be inserted into and fixed to the fixing portion 123.

Here, the embodiment of the present disclosure is not limited thereto, and the bracket 121 may be provided on the first housing 110. That is, the first housing 110 may be directly coupled to the bottom chassis 84, so that the second housing 120 may be fixed to the first housing 110.

The stand 140 may include an receiving portion 141 at least partially received in the housing 130, and a support portion 142 extending from a lower side of the receiving portion 141 and supporting the display apparatus 1 when the stand 140 is withdrawn.

The receiving portion 141 may be at least partially received in the housing 130 through an opening 131 of the housing 130 or may be withdrawn downward. The receiving portion 141 may be provided in a cylindrical shape.

The receiving portion 141 may be movably provided in a vertical direction of the display apparatus 1 by the guide portion 112 and may be also rotatably provided 90 degrees with respect to a vertical axis of display apparatus 1, which will be described later.

The support portion 142 may be formed to be substantially perpendicular to a longitudinal direction of the receiving portion 141. The support portion 142 may be formed in a cylindrical shape corresponding to the receiving portion 141, but is not limited thereto and may be formed in various shapes such as a square pillar.

The stand 140 may include a protrusion member 143 protruding from the receiving portion 141. The protrusion member 143 may be guided by the rail 160 to be described later to guide movement of the stand 140. The protrusion member 143 may be integrally formed with the stand 140, or may be formed by being inserted into the stand 140 in shapes of pin.

The stand unit 100 may include the elastic member 150 including an upper end 151 coupled to the housing 130 and a lower end 152 coupled to the stand 140.

The elastic member 150 may be provided so that the stand 140 receives a force in an upward direction of the housing 130 by continuously providing an elastic force to the stand 140 to be pulled upward of the housing 130.

The upper end 151 of the elastic member 150 may be coupled to the coupling portion 111 formed at the upper end of the first housing 110. However, the embodiment of the present disclosure is not limited thereto, and the coupling portion 111 may be provided on the second housing 120, so that the upper end 151 of the elastic member 150 may be coupled to the second housing 120.

The lower end 152 of the elastic member 150 may be coupled to the receiving portion 141. In detail, the receiving portion 141 includes an opening 141a opened to an upper, and the lower end 152 of the elastic member 150 or at least partial thereof are inserted into the receiving portion 141 through the opening 141a and may be coupled to a coupling member (not shown) formed on the inside of the receiving portion 141.

However, the embodiment of the present disclosure is not limited thereto, and the receiving portion 141 may not include the opening 141a, and the lower end 152 of the elastic member 150 may be coupled to the upper end of the receiving portion 141. In addition, the elastic member 150 may be coupled to any point that does not restrict movement of the receiving portion 141.

As described above, the elastic member 150 has one end coupled to the upper end of the housing 130 and the other end coupled to the stand 140. Accordingly, the elastic member 150 may exert an elastic force to the stand 140 so that the stand 140 is pulled upward of the housing 130.

The stand unit 100 may include the rail 160 that guides the protrusion member 143 of the stand 140 to guide the movement of the stand 140.

The rail 160 is disposed on the second housing 120 and may be provided in a slot shape into which the protrusion member 143 is inserted.

When the user presses the stand 140 downward, the rail 160 may be provided so that the protrusion member 143 moves downward along the rail to guide the stand 140 downward. In addition, when the user presses and rotates the stand 140, the rail 160 may be provided so that the protrusion member 143 rotates in the horizontal direction along the rail to guide the rotation of the stand 140.

As shown in FIG. 6, the rail 160 includes a first section 161 extending in a vertical direction, a second section 165 extending in a curve from a lower end of the first section 161, and a third section 163 extending in a horizontal direction from the lower end of second section 165.

The rail 60 may include a first stopper 162 provided at an upper end of the first section 161 or an upper end of the rail 160, and a second stopper 164 provided at a distal end of the third section 163 or a lower end of the rail 160.

FIG. 6 is a view showing an insertion position 100A of the stand 140 received in the display apparatus 1. When the stand 140 is positioned in the insertion position 100A, the protrusion member 143 may be placed so that the first stopper 162 is in contact with the upper side thereof.

Since the movement of the protrusion member 143 is restricted by the first stopper 162, the stand 140 may maintain the insertion position 100A when the elastic member 150 pulls the stand 140 upward.

As shown in FIG. 7A, when the user presses the support portion 142 downward, the protrusion member 143 moves downward along the first section 161, resulting in the stand 140 moving downward.

At this time, the elastic member 150 provides a force to pull the stand 140 upward to the stand 140, but when the force applied by the user is greater than that of the elastic member, the stand 140 may be moved downward.

Thereafter, as shown in FIG. 7B, the protrusion member 143 may be positioned in the second section 165 extending from the lower end of the first section 161. The second section 165 may have a curved shape and may extend from an upper side to a lower side thereof. Accordingly, when the user presses the support portion 142 in the downward direction, the protrusion member 143 is moved along the second section 165, so that the stand 140 may be moved downward while rotating to the left in the direction viewed in FIG. 7B.

In other words, the second section 165 may be provided so that the protrusion member 143 smoothly moves downward along the curved shaped thereof, resulting in the stand 140 moving downward while rotating. The shape of the second section 165 is not limited to the curved shape and may be formed in an oblique shape.

Thereafter, as shown in FIG. 7C, the protrusion member 143 may be positioned in the third section 163 extending from the lower end of the second section 165.

Since the third section 163 is not formed in the vertical direction but formed in the horizontal direction, the stand 140 may not move downward when the user presses the support portion 142 downward.

The user may then press and rotate the support portion 142 to the left in the direction viewed in FIG. 7C, and in this case, the protrusion member 143 is moved to the left along the third section 163 so that the stand 140 may be rotated to the left. FIG. 7C is a view showing a state in which the protrusion member 143 has been moved to the distal end of the third section 163 along the third section 163.

The second section 165 and the third section 163 may be provided so that the stand 140 may be rotated 90 degrees relative to the insertion position 100A. That is, when the protrusion member 143 is moved from the upper end of the second section 165 to the distal end of the third section 163, a position or a distance of the upper end of the second section 165 and the distal end of the third section 163 may be adjusted so that the stand 140 rotates 90 degrees from the insertion position 100A.

The rail 160 by the second section 165 and the third section 163 may guide the stand 140 to move downward while rotating the stand 140 by 90 degrees from the insertion position 100A.

The support portion 142 is provided to be arranged in a longitudinal direction in a direction corresponding to the longitudinal direction of the display apparatus 1 in the insertion position 100A, and the stand 140 may be withdrawn from the housing 130 by the user to be positioned in a withdrawal position 100B.

When the stand 140 is positioned in the withdrawal position 100B, the support portion 142 is rotated 90 degrees relative to the insertion position 100A so that the longitudinal direction of the support portion 142 may be arranged in perpendicular to the longitudinal direction of the display apparatus 1.

As shown in FIGS. 8 and 9, when the stand 140 is positioned in the withdrawal position 100B, at least part of the receiving portion 141 may be withdrawn downward.

When the protrusion member 143 is reached at the distal end of the third section 163, the protrusion member 143 may be moved to the second stopper 164 formed upward from the distal end of the third section 163.

As the stand 140 moves downward, the elastic member 150 is interlocked with the stand 140 to be increased the length thereof. Accordingly, the elastic member 150 may be provided to the stand 140 with a force that continuously pulls the stand 140 upward.

As a result, the protrusion member 143 may be smoothly moved from the distal end of the third section 163 to the second stopper 164 by the elastic member 150.

That is, the protrusion member 143 may be moved upward from the distal end of the third section 163 at a predetermined level, and the upper side of the protrusion member 143 may be contact with the second stopper 164. Since the second stopper 164 restricts the protrusion member 143 from moving upward, the stand 140 may maintain the withdrawal position 100B.

Even when the stand 140 is positioned in the insertion position 100A or the withdrawal position 100B, the stand may be maintained the position by the first stopper 162 and the second stopper 164, respectively.

The stand 140 may be moved by a height difference h between the first stopper 162 and the second stopper 164 in the vertical direction. That is, the stand 140 may be withdrawn from the housing 130 by the height difference h between the first stopper 162 and the second stopper 164 in the vertical direction at the insertion position 100A.

In other words, a height difference h between the insertion position 100A and the withdrawal position 100B may be the same as the height difference h between the first stopper 162 and the second stopper 164 in the vertical direction.

Accordingly, a height of the display apparatus 1 supported from the floor may substantially correspond to the height difference h between the insertion position 100A and the withdrawal position 100B.

Hereinafter, a state when the display apparatus 1 is installed on the wall or on the floor will be described.

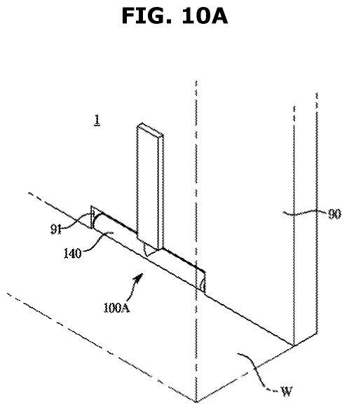

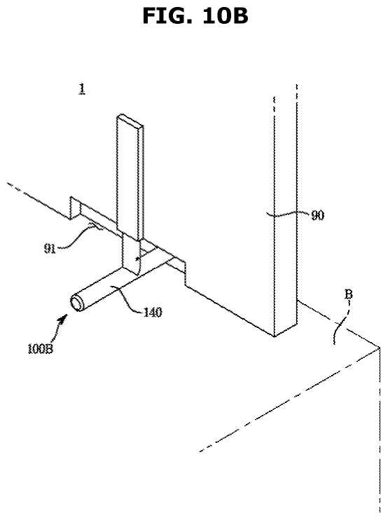

FIGS. 10A to 10B are rear perspective views of the stand unit of the display apparatus in the insertion position and the withdrawal position according to the embodiment of the present disclosure.

As shown in FIG. 10A, when the display apparatus 1 is installed on the wall surface W, the stand 140 may be placed in the insertion position 100A.

The lower end of the stand 140 in the insertion position 100A may be arranged at a position corresponding to a lower end of the rear cover 90 or higher than the lower end of the rear cover 90. Accordingly, when the user looks at the front of the display apparatus 1, the stand 140 may not be exposed to the outside.

That is, the lower end of the stand 140 in the insertion position 100A may be arranged at a position corresponding to the lower end of the display apparatus 1 or higher than the lower end of the display apparatus 1.

As shown in FIG. 10B, when the display apparatus 1 is installed on the floor surface B by the stand 140, the stand 140 may be positioned in the withdrawal position 100B.

The user may pull the stand 140 disposed at the rear surface side of the display apparatus 1 downward to withdraw the stand 140 received in the display apparatus 1.

The through holes 91 of the rear cover 90 may be cut across the lower surface and the rear surface of the rear cover 90. The reason why the through holes 91 are cut to the rear of the rear cover 90 is to allow the user to easily grip the stand 140 and press it downward.

Several embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

1. A display apparatus, comprising:
a display panel configured to display an image forward;
a top chassis arranged on a front side of the display panel;
a bottom chassis arranged on a rear side of the display panel;
a rear cover covering a rear side of the bottom chassis; and
a stand unit arranged between the bottom chassis and the rear cover and coupled to the rear surface of the bottom chassis;
wherein the stand unit comprising:
a housing coupled to the bottom chassis,
a stand configured to be received in the housing through an opening formed on a lower side of the housing, and
an elastic member configure to transmit elastic force to the stand from an upper inside of the housing.

2. The display apparatus of claim 1, wherein
the housing includes a coupling portion disposed on an upper side of the housing and coupled to an upper end of the elastic member, and
the stand is coupled to a lower end of the elastic member.

3. The display apparatus of claim 1, wherein
the stand further includes a protrusion member, and
the housing further includes a rail configured to guide the protrusion member.

4. The display apparatus of claim 3, wherein
the rail includes a first section guiding the protrusion member in a vertical direction, a second section extending from the first section and guiding the protrusion member to be rotated and moved, and a third section extending from the second section and guiding the protrusion member in a horizontal direction.

5. The display apparatus of claim 3, wherein
the rail includes a first stopper provided at one end of the rail and restricting the protrusion member from moving upward, and a second stopper provided at the other end of the rail and restricting the protrusion member from moving upward.

6. The display apparatus of claim 5, wherein
the stand is provided to be movable vertically by a distance between the first stopper and the second stopper.

7. The display apparatus of claim 5, wherein
the stand is provided such that when the protrusion member is placed on the second stopper, the protrusion member is rotated by 90 degrees compared to when the protrusion member is placed on the first stopper.

8. The display apparatus of claim 6, wherein
the stand further includes a receiving portion at least partially received in the housing and a support portion extending downward from the receiving portion and supporting the display apparatus, and
the protrusion member is provided on the receiving portion.

9. The display apparatus of claim 8, wherein
the receiving portion is configured to be withdrawn from the rear cover to support the display apparatus when the protrusion member is placed on the second stopper.

10. The display apparatus of claim 3, wherein
the rail is provided to rotate 90 degrees while the stand is moved in the vertical direction.

11. The display apparatus of claim 3, wherein
the housing includes a first housing including a coupling portion to which an upper end of the elastic member is coupled and a guide portion for guiding the stand, and a second housing on which the rail is provided.

12. The display apparatus of claim 11, wherein
the second housing further includes a bracket coupled to the bottom chassis, and
the first housing further includes a fixing portion fixed to the bracket.

13. The display apparatus of claim 1, wherein
the stand is configured to move between a first position in which the stand is received in the housing and a second position in which the stand is withdrawn and supports the display apparatus, and
when the stand is placed on the first position, a lower end of the stand is provided to correspond to a lower end of the rear cover in a front-rear direction or higher than the lower end of the rear cover.

14. The display apparatus of claim 13, wherein
the rear cover includes a through hole through which the stand passes in a vertical direction.

15. The display apparatus of claim 13, wherein
the lower end of the stand is provided to correspond to a lower end of the display apparatus in a front-rear direction or higher than the lower end of the display apparatus when the stand is placed on in the first position.
